(19) United States
(12) Patent Application Publication
(10) Pub. No.: US 2015/0258674 A1
(43) Pub. Date: Sep. 17, 2015

(54) Handle with Attachments

(71) Applicant: Dave Steinick, Dallas Center, IA (US)

(72) Inventor: Dave Steinick, Dallas Center, IA (US)

(21) Appl. No.: 14/213,432

(22) Filed: Mar. 14, 2014

(51) Int. Cl. B25G 1/10; B25G 1/04

(52) U.S. Cl. CPC B25G 1/102; B25G 1/04

(57) ABSTRACT

The device includes an innovative handle construction designed to provide utility and interchangeable uses. The handle includes an “S” shaped portion that functions as a hand grip, its first end of the “S” associated with a tool, and its second end associated with a base portion extending to accommodate a forearm rest. The device may also include an extender section between the first end of the “S” and the tool to provide even more utility. The forearm rest of the device may be adjusted relative to its position on the base section so that the length of the user's forearm can be adequately accommodated for ease and efficiency of use.

### FIELD OF INVENTION

The present invention is related to utility devices that include a handle and pole, with a utilitarian object at the end. More specifically, it is related to extended poles that have a tool at the end such as a basket, a net, a light bulb changer, a hook, etc.

### SUMMARY OF THE INVENTION

The present invention allows a user to employ a single pole with any one of several attachments to achieve and accomplish a variety of tasks. The primary pole may be in one or multiple portions, in addition to the attachment which may or may not also include a pole-like portion, or even a telescopically or otherwise adjustable extendable pole-like portion. The primary pole, whether in one or more portions, includes an “S” shape having a segment perpendicular to the primary pole portion(s) and a forearm rest near the “S” so that the user can grip the vertical portion of the “S” and rest his forearm against the forearm rest at the same time. The attachment is positioned on the opposite side of the “S” from the forearm rest. There may or may not be a third pole portion between the attachment and the “S”; this third pole portion may be detachable from the “S” portion of the primary pole thereby allowing different lengths past the “S” portion. The third pole section may be telescoping in nature, the use of the “S” arrangement allows for more stability when using the tool, more leverage for moving heavier items as desired. Alternatively, or additionally, the forearm rest may include a peg perpendicular to the rest, said peg for gripping by the user, rather than using the perpendicular portion of the “S” as a grip. Providing any one of these arrangements creates a utility pole that may include interchangeable attachments that may be selected for the task at hand.

### DRAWINGS

FIG. 1 is a perspective view of the invention;

FIG. 2 is a side view of the invention;

FIG. 3 is a top view of the invention;

FIG. 4a is a side view of the “S” portion, including one embodiment of a hand grip;

FIGS. 4b-d are side views of the “S” portion and various means to associate;

FIG. 5-8 are side views of a variety of arrangements for associating the primary pole and “S” with an attachment.

FIGS. 9-11 provide three side views of different attachments with the primary pole

FIGS. 12-14 provide three up close views of the forearm rest.

FIG. 15 shows the present invention and an extender portion.

FIG. 16 provides a view of the extender portion incorporated in the invention.

### DETAILED DESCRIPTION

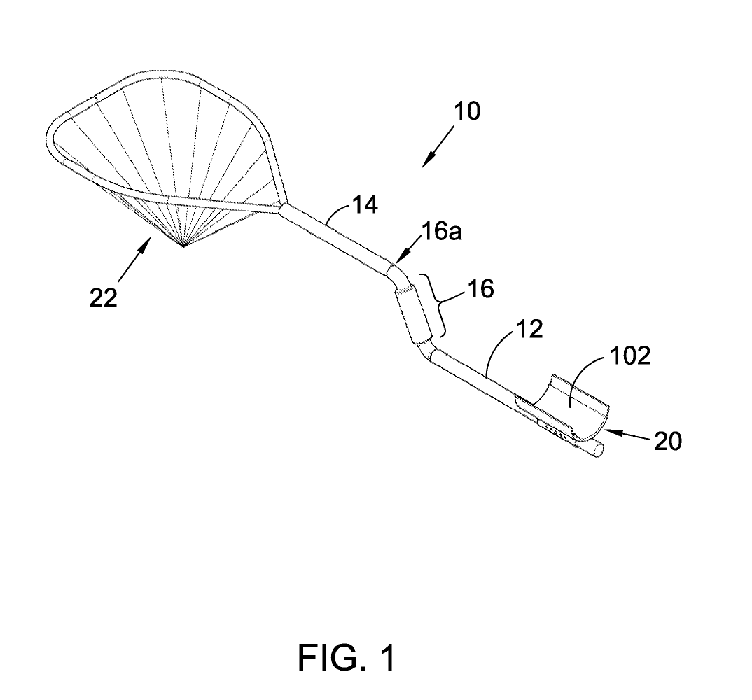

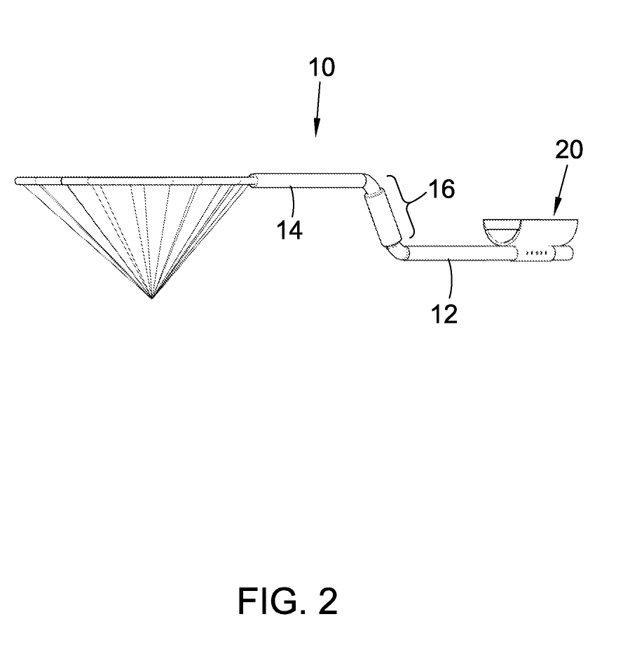

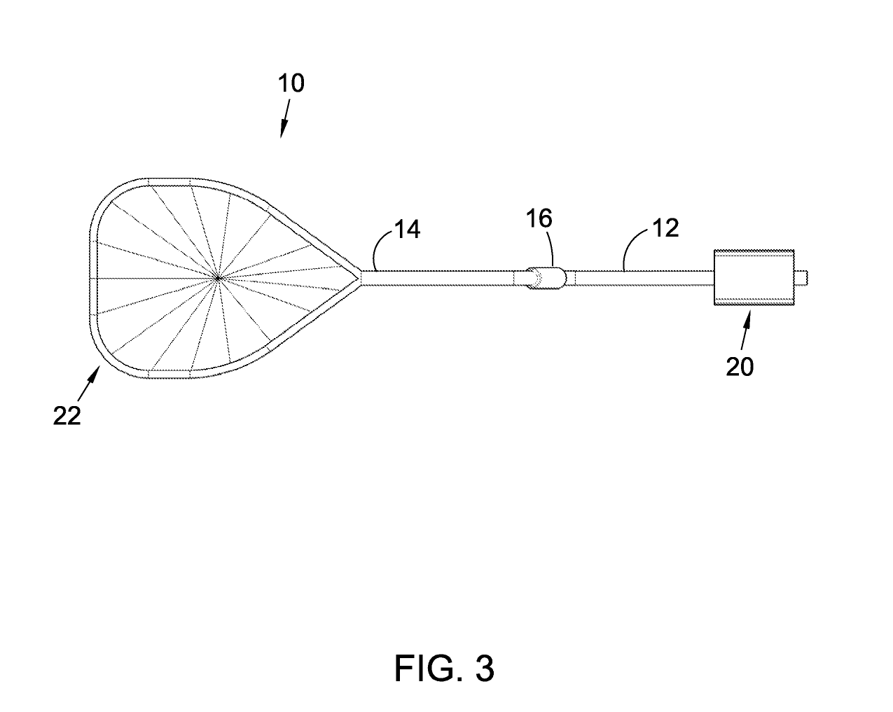

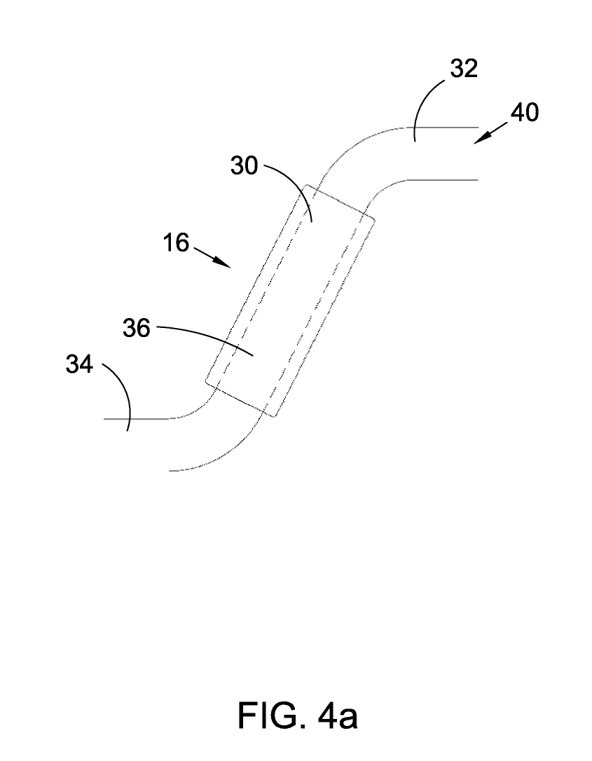

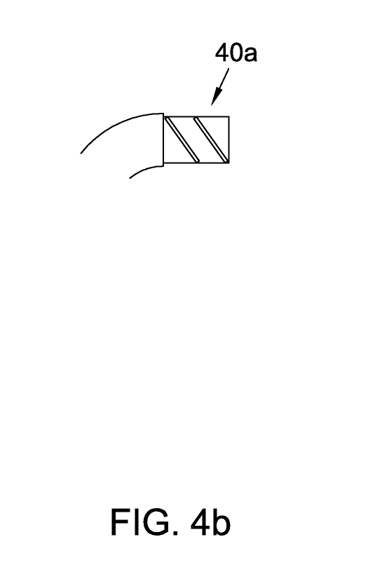

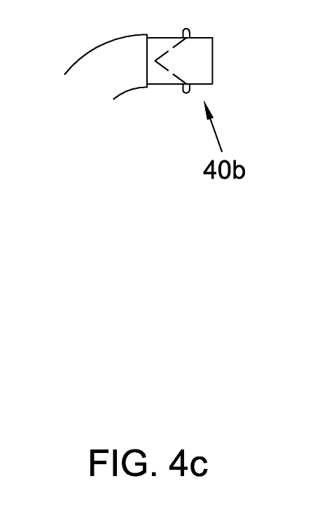

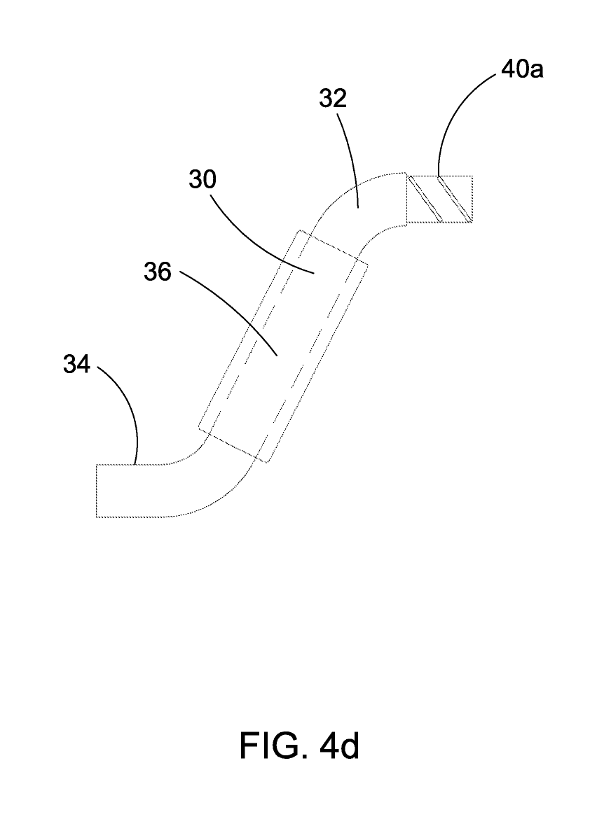

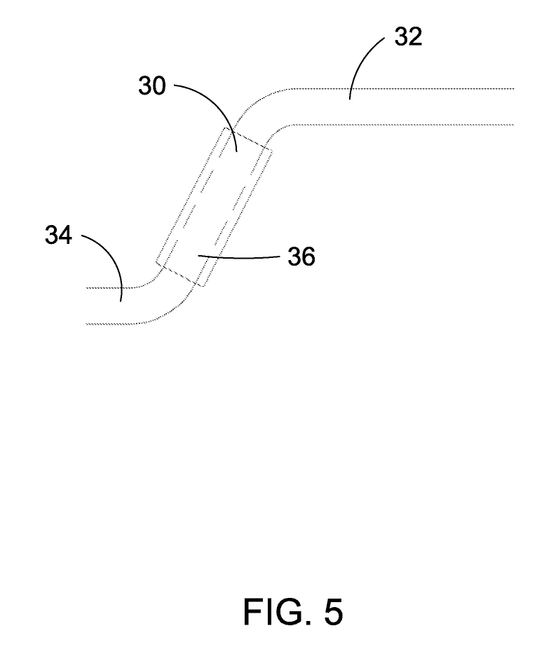

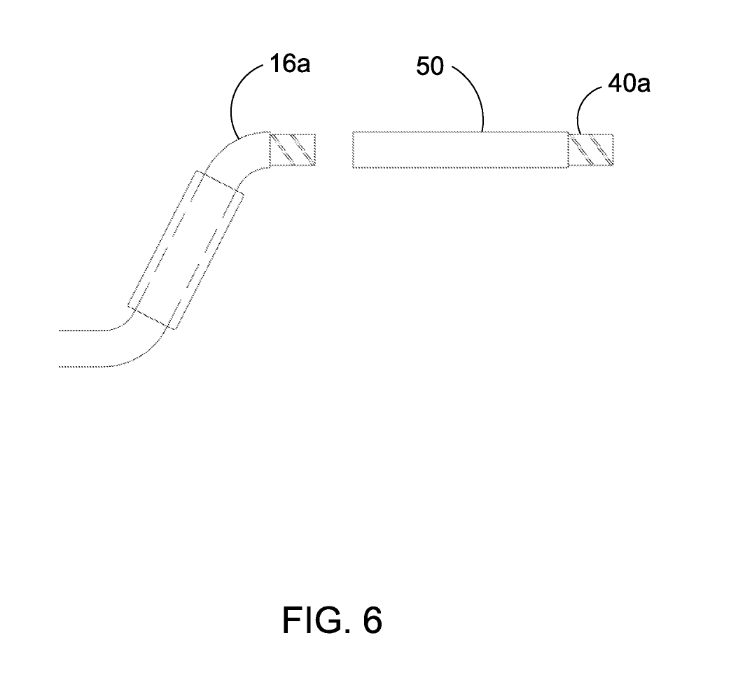

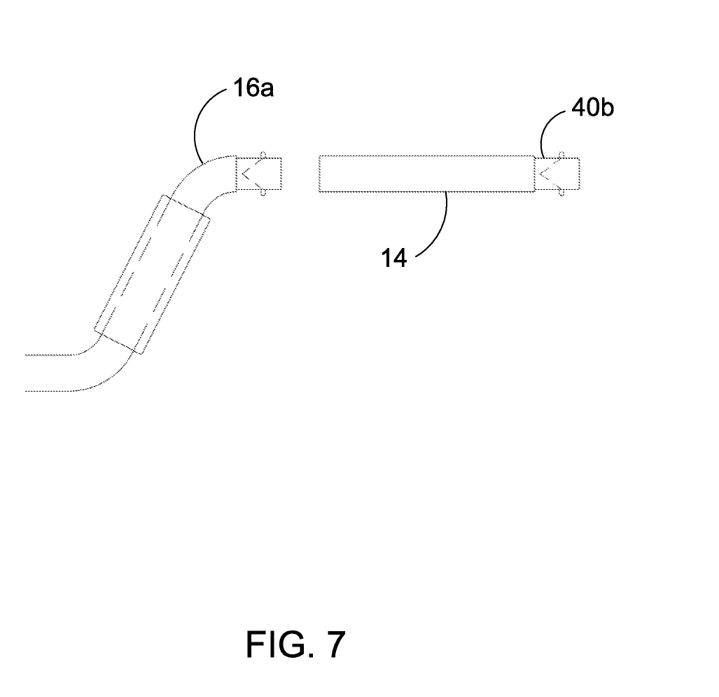

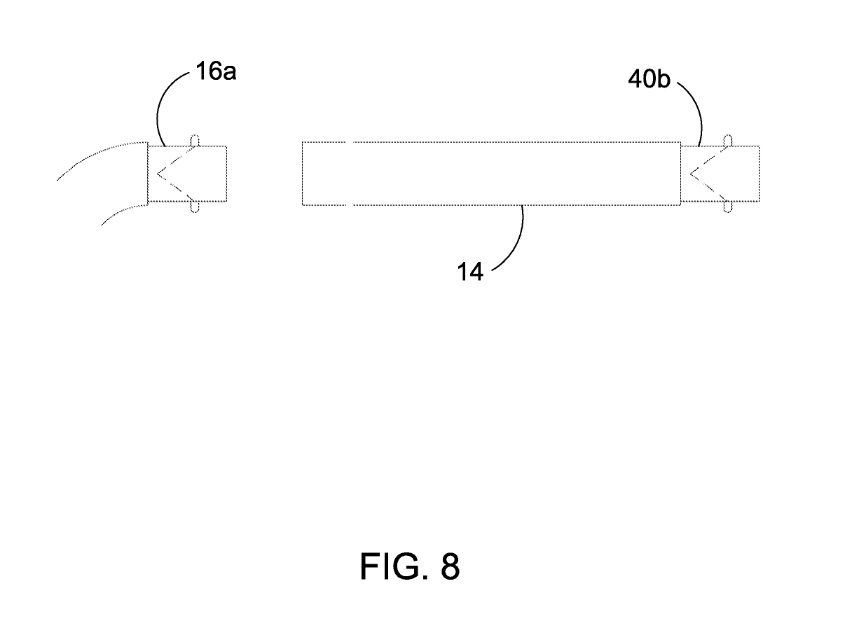

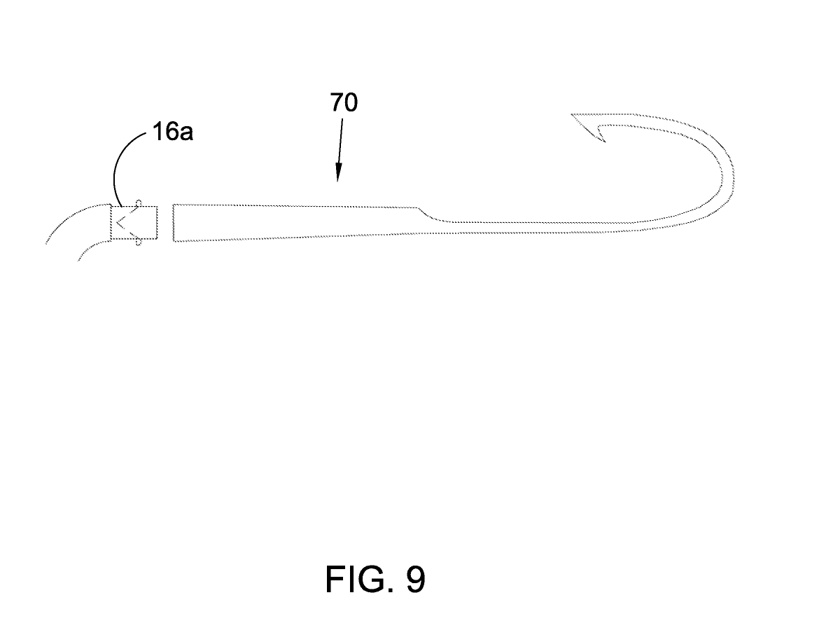

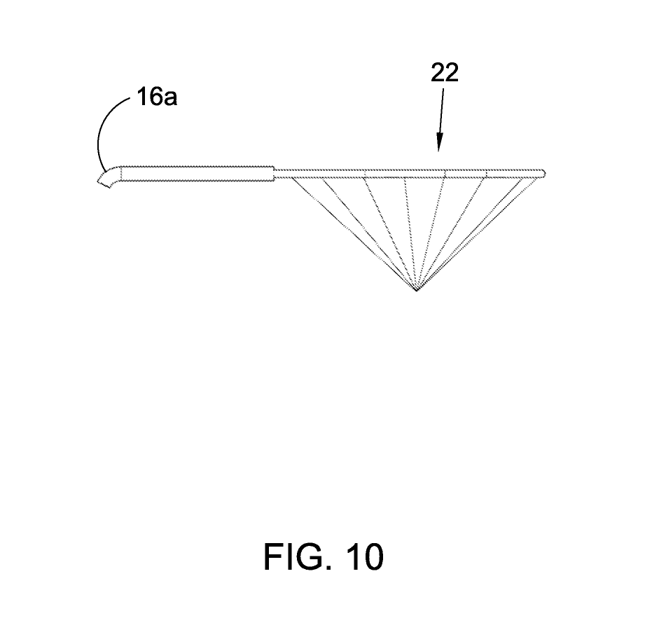

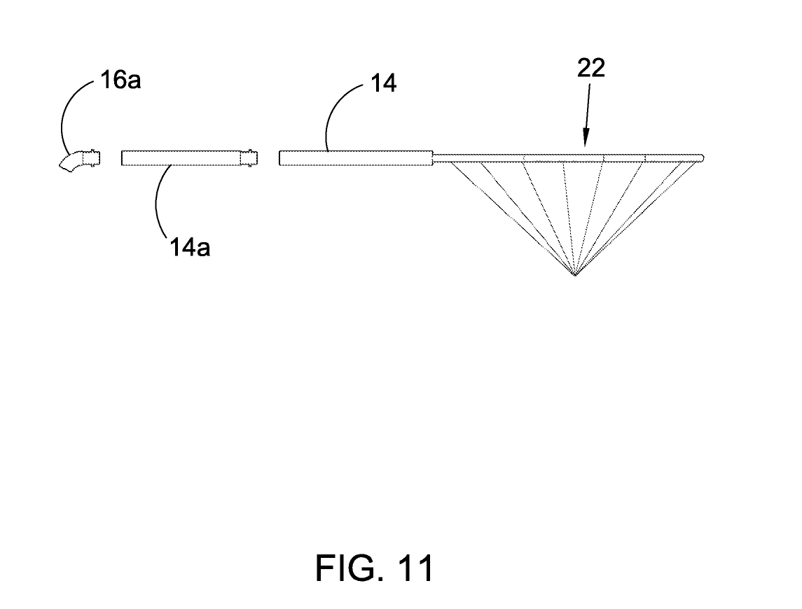

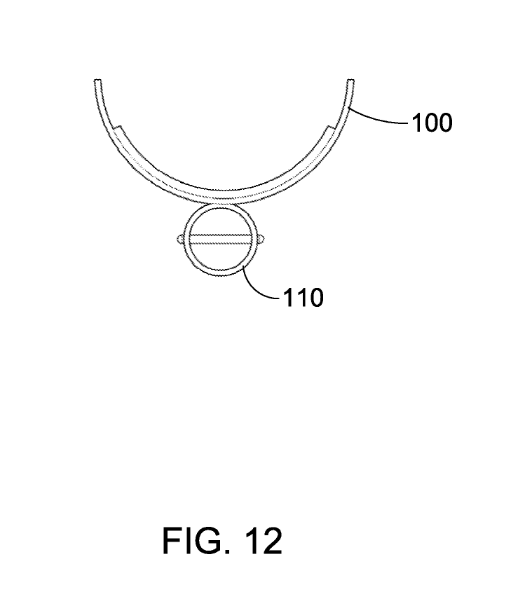

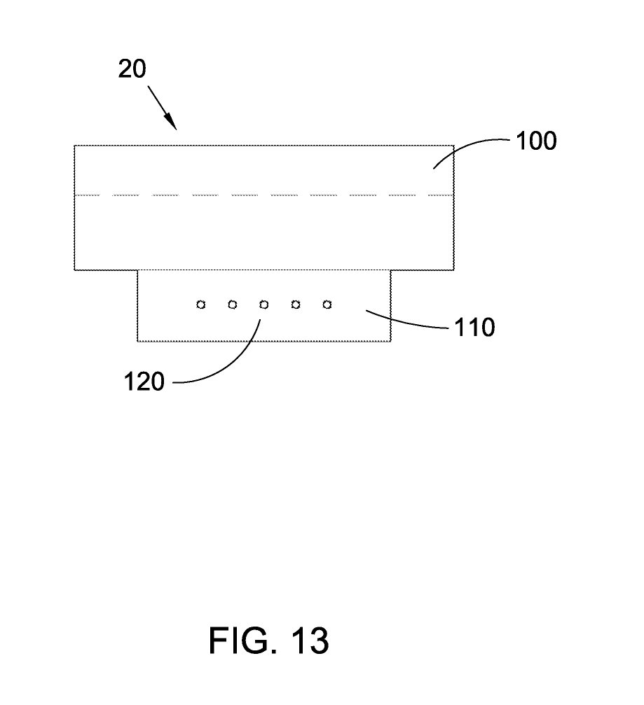

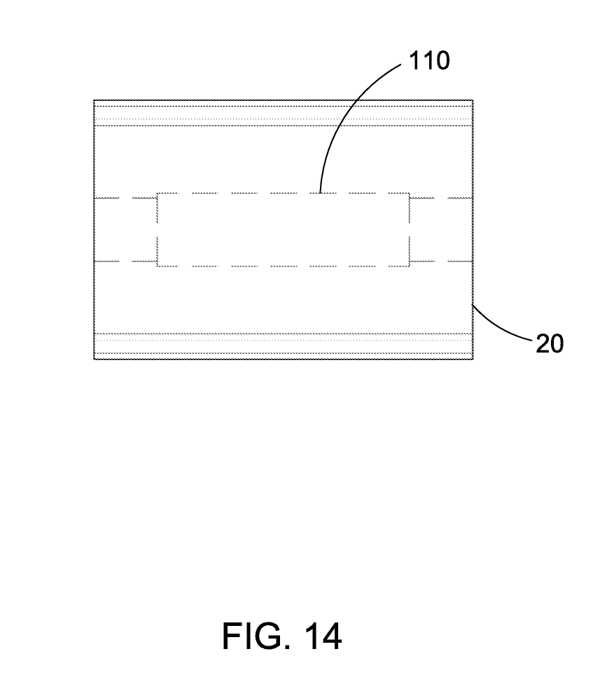

Referring now to FIGS. 1-3, the present invention provides a device 10 for a variety of uses. The tool 10 typically includes a base section 12, an “S: portion 16, and a tool 22. The tool 22 may be a net, a gaff, or any other tool with a use that may be enhanced by a handle of the foregoing description. The tool 22 may be associated with a first end 16a of the “s” portion 16 through any of a number of means to associate 40, including mating threads 40a on the first end 16a of the “S” 16 and threads 40a on the tool 22, or holes 40a on either the first end 16a of the “S” 16 or the tool 22 and spring loaded pegs 40b on the other; the pegs 40b to be inserted through the holes to secure the tool 22 to the first end 16a of the “S” portion 16. Means to associate 40 may also be as simple as a friction fit between the tool and the “S” portion.

In another embodiment, a first extender section 14 is included between the tool 22 and the first end 16a of the “S” 16 to provide a longer reach for better use of the tool 22. Extender 14 may include a telescoping portion to allow adjustable length and reach. The extender section 14 is provided with means to associate 40 with the first end 16a of the “S” and means to associate 40 with the tool 22. Once again means to associate 40 the extender section 14 may be of any of a number of methods, or may include one device at one end and another device at another, so long as the first extender section is secured both to the tool 22 and to a first end 16a of the “S” 16. By way of illustration, but not limitation, such means to associate 40 may include any of bolt and nut, hairpin cotter, clevis pin, hitch pin, lanyard pin, toggle type quick pin (with or without ring), ball lock pin, top fitting quick pin, quick release pins, T-handle, L-handle, button-handle spring pin, gibralter handle, pin with flip tab, ball detent, spring loaded ball detent, ball handle, lynch pin, square or round snap pin, square or round lock pin.

The “S” portion 16 may be equipped with a hand grip section 30 between the first end 16a of the “S” and a second end section 16b of the “S” portion 16. The hand grip section 30 may be provided with a hand grip 36 which may be comprised of a neoprene or other material to enhance both the comfort of the user and increase the friction between the hand of the user and the grip section 30 itself. The hand grip section 30 may be at or near a right angle or an angle between about 90 and about 130 or more with the base portion 12 or the first end 16a of the “S” portion to provide comfort to the user and leverage for the tool.

In an embodiment, the base section 12 includes a forearm rest 20. The forearm rest 20 may comprise means to associate 110 the rest 20 with the base portion 12. Said means to associate 110 may be the same or different than means to associate 40. The rest 20 may include a semi-circular portion 100 in which the user places his forearm. The rest 20 may also be provided with a rubber or neoprene liner 102 to provide additional comfort and/or to provide better stability through a friction grip. The forearm rest 20 is associated with the base section 12 by one of a number of different means. In one embodiment the forearm rest 20 may be selectively positioned on the base section 12 so that the position corresponds with the user's arm length. The forearm rest 20 can be positioned via openings 120 positioned either on the means to associate 110 or on the base portion 12, and spring loaded pegs 110a positioned on the base portion 12 or the means to associate 110, respectively. Spring loaded pegs could, instead, be wingnut and threaded peg, or both the base portion 12 and the means to associate 110 could be provided with openings through which a third element could be inserted to secure the relative positions of the forearm rest 20 and the base portion 12. Alternatively, the forearm rest 20 may be provided with a cuff that fits around the base portion 12, and can be tightened to provide a friction fit. In yet another embodiment, the forearm rest 20 and the base portion 12 are secured relative to one another, and the forearm rest 20 is provided with the semi-circular portion 100. The position of the semicircular portion 100 can be adjusted relative to the forearm rest via springloaded pegs and holes, wingnut and threaded peg, openings and pegs, or friction fit device.

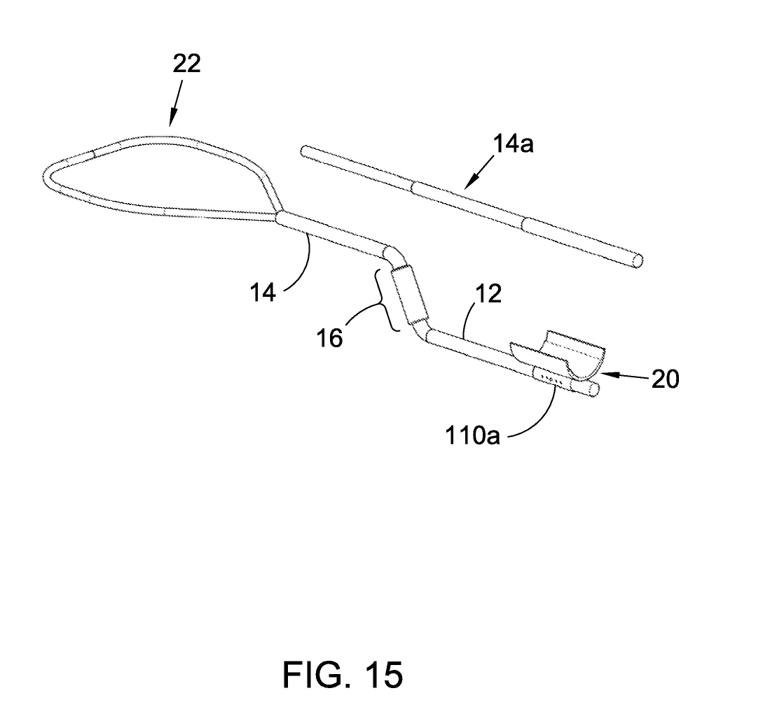

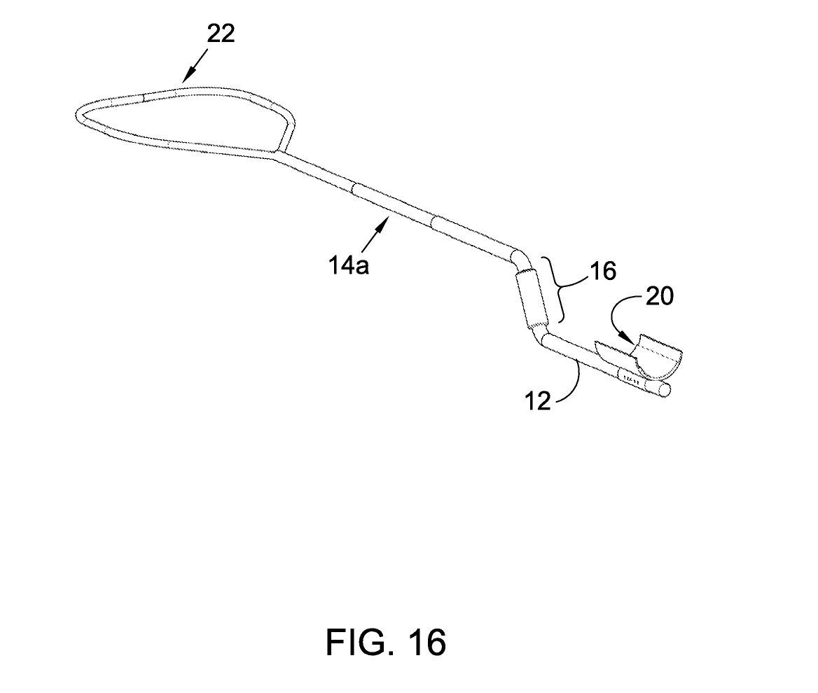

During use the user adjusts the distance between the tool 22 and the “S” 16 by selecting and assembling the appropriate extender section 14 with the first end 16a of the “S”, and positioning the forearm rest 20 as needed for fit. He then places forearm on the rest 20, and grips the hand rest 30 at the “S” portion 16. It should be understood that additional or different extender portions 14 can be added as needed for the given use. For example, FIG. 15 shows the invention having an extender portion 14 and a second extender portion 14a not yet associated with the invention. In FIG. 16, the first extender portion 14 has been removed and the second extender portion 14a has been positioned in its place at the first end 16a of the “S” 16. Alternatively, the first and second extender portions, 14 and 14a, may be employed simultaneously for additional length. Many different tools may be associated with extender portion 14 or directly with the first end 16a of the “S” 16.

The tool 22 may be a fish net, a gaff 70, or anything that may benefit from the grip and forearm rest combination of the present invention which provides stability, comfort, and means to control the placement of the tool while using leverage to increase the user's power to move, place and use the tool 22.
10 device
12 base section
14 first extender section
14a second extender section
16 “S” portion,
16a “S” first end
16b “S” second end
20 forearm rest
22 tool
30 hand grip section
32 first end of “S”
34 second end of “S”
36 hand grip
40 means to associate S with tool 22
40a threads or holes
40b pegs
100 semi-circular portion of forearm rest 20
110 means to associate the rest 20 with the base section 12

What I claim is:

1. A device comprising a tool, a base section, and an “S” portion between said tool and said base section, said “S” portion having a hand grip section, said tool associated with a first end of the “S” and said base section associated with a second end of the “S” portion.

2. The device of claim 1 further comprising a forearm rest associated with the base section.

3. The device of claim I further comprising a first extender section between the tool and the first end of the “S” portion, and a forearm rest associated with the base section.

4. The device of claim 2 further comprising means to adjust the position of the forearm rest relative to the base section.

5. The device of claim 4 wherein said means to adjust comprises at least one openings on the forearm rest and at least one spring loaded peg on the base section.

6. The device of claim 2 wherein said device further comprises means to associate the tool and the first end of the “S” portion.

7. The device of claim 6 wherein said means comprises threads on said tool and said first end of the “S” section comprises mating threads.

8. The device of claim 6 wherein said means comprises at least one spring loaded peg on said first end of the “S” portion.

9. The device of claim 6 wherein said means comprises a friction fit between the tool and the first end of the “S” section.

10. The device of claim 3 wherein said device further comprises means to associate the tool and the extender portion.

11. The device of claim 10 wherein said means consists of one of the following: a first plurality of mating threads on said extender and a second plurality of mating threads on said tool, at least one spring loaded pg on said extender and at least one opening on said tool, at least one spring loaded peg on said tool and at least one opening on said extender, and a friction fit between said extender and said tool.

12. The device of claim 2 wherein said forearm rest comprises a semi-circular section.

13. The device of claim 12 further comprising means to adjust the position of the forearm rest relative to the base section.

14. The device of claim 13 wherein said means to adjust the position of the forearm rest comprises a plurality of openings on said forearm rest, at least a pair of openings on said base section, a peg, and means to secure said peg in said openings.

15. The device of claim 13 wherein means to adjust the position of the forearm rest comprises a plurality of openings and at least one spring loaded peg.

16. The device of claim 13 wherein means to adjust the position of the forearm rest comprises a slot in the rest, at least one opening in the base section, and means to apply pressure between the slot and the base section to secure said forearm rest in a desired position.

17. The device of claim 2 wherein said hand grip is provided with at least a partial sleeve of material to improve grip and comfort and the forearm rest is provided with at least a partial liner to improve stability of position and comfort.
